(19) United States
(12) Patent Application Publication
(10) Pub. No.: US 2020/0243230 A1
(43) Pub. Date: Jul. 30, 2020

(54) DOPED MAGNETIC NANOPARTICLES

(71) Applicant: NANO THERANOSTICS, INC, Elmsford, NY (US)

(72) Inventors: Rameshwar N. Bhargava, Ossining, NY (US); Robert L. HARTMAN, Warren, NJ (US); Adosh Mehta, New City, NY (US); Christian Michel, Ossining, NY (US); Vyom Parashar, Ossining, NY (US); Rajan Pillai, New York, NY (US)

(21) Appl. No.: 16/488,201

(22) PCT Filed: Feb. 23, 2018
(86) PCT No.: PCT/US2018/019458

§ 371 Date: Aug. 22, 2019

(51) Int. Cl. H01F 1/00; H01F 1/03; H01F 41/02

(52) U.S. Cl. CPC H01F 1/0054; H01F 1/0063; H01F 41/0273; H01F 1/03

(57) ABSTRACT

Ferromagnetic nanoparticles which are converted from paramagnetic, antiferromagnetic, ferrimagnetic or weak ferromagnetic nanoparticles by incorporation of a dopant, the dopant having a concentration less than 0.5%. Major changes occur in the magnetic properties of the host material. A weak paramagnetic material such as Mn₃O₄ is been converted to a ferromagnetic material that has a Curie point beyond 700° C. and shows almost temperature independent coercivity and magnetic moment. These ferromagnetic nanoparticles can be used as contrast agent, as a vehicle for targeted drug delivery, high temperature magnets, high density magnets, magnetic circuits and many more devices utilizing local interaction of the magnetic field.

### BACKGROUND AND SUMMARY OF THE INVENTION

This application is directed ferromagnetic nanoparticles which are converted from paramagnetic nanoparticles by a dopant.

This conversion of paramagnetic to ferromagnetic nanomaterial is achieved by incorporating a single magnetic impurity-ion (dopant) in a paramagnetic nanocrystal host.

The spin exchange interaction between the polarized spin of the dopant and host spins results in ferromagnetism that persists beyond 700° C., a new result shown for the case of Fe doped Mn₃O₄ nanoparticles. The induced ferromagnetism in nanoparticles and its control with a magnetic dopant ion, size of host, and crystalline structure of the host is demonstrated herein. The demonstration of ferromagnetism at temperatures above 700° C. in doped magnetic nanoparticles (DMNP) creates a new class of high temperature ferromagnetic materials (HT-FM) from non-ferrous materials. Integration of magnetically aligned DMNPs in a metallic matrix will generate macro-magnets with high coercivity that can function at high temperature. These HT-FM magnets have applications in next generation electro-mechanical systems. The use of these DMNP as a contrast agent for MRI and for targeted drug delivery are two other applications that are described herein in addition to high temperature magnets for motors, bearings, nanomagnetic memory arrays and nanomagnet photonic devices such as display arrays.

The dopant induced modulation of electrical and luminescent properties of semiconductors and phosphors, respectively, has created the vast computer and lighting industries However, a similar dopant based modulation of magnetic properties has yet to be achieved. We demonstrate herein for the first time that magnetic properties can be modulated very efficiently when a magnetic impurity as a dopant is incorporated into a paramagnetic or ferromagnetic nanoparticle. The key difference is that in semiconductors or insulators only electrical conductivity or luminescent properties are modulated by the dopant without affecting any of the intrinsic property of the host such as crystal symmetry or host-spin orientation.

In the case of magnetic materials, the exchange interaction between the dopant spin and host spins not only impacts and modulates the magnetic properties but also imposes changes on the crystalline symmetry of the host. The simultaneous phase transition in the crystalline and magnetic symmetry in doped magnetic nanoparticles (DMNP) can only be induced if the nanosize of the average particle is in the range of 30 nm or below. If the size of host is kept below 30 nm, the exchange interaction can lead to changes in the crystalline phase of the host, phenomena not previously observed. The cause of the collective change of both magnetic property and the crystalline phase is a result of spin-exchange interaction between spins of dopant and host magnetic-ions that significantly changes magnetic properties of the host material. This breakthrough can be used to create a new class of magnetic materials heretofore not known.

The exchange interaction refers to the magnetic interaction between electrons within an atom, which is determined by the orientation of each electron's magnetic ‘spin’—a quantum mechanical property. We describe the enhancement of the ‘exchange interaction’ by introducing a single dopant atom with net magnetic spin in a paramagnetic nanocrystal. The quantum confinement of this dopant's single spin provides the added ‘exchange interaction’. This has resulted in significantly increasing the Curie temperature and the coercivity of the host material. These improved magnetic properties and their application to devices is the subject of this work. These DMNPs can be integrated to fabricate large magnets.

From the observation of linearly polarized light generated by a single quantum confined atom (QCA) in a nanoparticle [R. N. Bhargava et.al. Physical Review Letters, 72, 416, 1994] and that only a single dopant was incorporated per nanocrystal [M. D. Barnes et al., J. Phys. Chem. B 104 (2000) 6099: A P. Bartko et.al. Chemical Physics Letters 358 (2002) 459-465] we concluded that by incorporating a single magnetically polarizable atom in a magnetic nanoparticle, a magnetic ordering is triggered and produces nanomagnets of sizes <30 nm. This was the subject of two issued U.S. Pat. Nos. 7,175,778 and 7,993,541. A distortion along a crystallographic axis polarizes the spin and the orbital magnetic moment of the QCA in a fixed direction. The spin-spin exchange interaction of this fixed magnetic moment of a QCA with a host element's spin will trigger the host spins to line up, thus resulting in a nanomagnet. We expect that magnetic anisotropy energy in this case, to be significantly larger than thermal energy kT at room temperature. In this work, we have advanced the teachings of our earlier patents with novel materials and processes to demonstrate the development of much stronger nanomagnets that remain ferromagnetic at temperatures beyond 700 C.

Engineered magnetic nanoparticles have the potential to revolutionize the diagnosis and treatment of many diseases, for example, by allowing the targeted delivery of a drug to particular subsets of cells. However, thus far, magnetic nanoparticles have not proved capable of surmounting all of the biological barriers required to achieve this goal. Nevertheless, recent advances in magnetic nanoparticle engineering, as well as advances in understanding the importance of magnetic nanoparticle characteristics such as size, shape and surface properties for biological interactions, are creating new opportunities for the development of magnetic nanoparticles for effective therapeutic applications. This application describes a breakthrough development for the design of such doped magnetic nanoparticles that will enable us to realize the potential applications for targeted drug delivery by means of the conversion of a paramagnetic DMNP (which is attached to a biological cytotoxic agent and/or a monoclonal antibody to a ferromagnetic DMNP at the target site under the influence of a uniform magnetic field. In addition, other applications that consist of DMNP based integrated nanomagnet devices will be described. These newly developed DMNPs enable many other unique developments of previously difficult or novel device applications such as improved contrast agents for MRI; high temperature magnets for motors; high temperature magnets for bearings; new designs for electrical generators; non-rare earth high strength magnets; nanomagnet arrays; and nanomagnetic-optical switches.

### BRIEF DESCRIPTION OF THE DRAWINGS

FIG. 1: Depicts the transition from superparamagnetic to single to multi-domain regimes. The transition point from superparamagnetic to single-domain to multi-domain for each type of MNP also depends upon the increasing size and/or geometry of the nanoparticles

FIG. 2. Depicting on the top-half the magnetic behavior of undoped MNP; (i) paramagnetism, (ii) antiferromagnetism, (iii) ferrimagnetism and (iv) ferromagnetism. The surface spins are randomly oriented in all cases due to disordered nature of the surface. When a single dopant spin is incorporated, as shown in lower-half for all four different types of magnetic nanoparticles, all of the spins in the core and on the surface are aligned yielding perfectly spin-aligned nanoparticles which results in very high temperature ferromagnetism.

FIG. 3. HRTEM pictures of (a) undoped and (b) doped MNPs On the left, the undoped MNPs are agglomerated at random while on the right, all the doped MNPs particles are aligned with the growth axis due to presence of intra-particle magnetic interaction.

FIG. 4. Plot of Magnetization (M) vs. applied magnetic field (H) at room temperature (25 C) in Fe-doped Mn₃O₄ MNP.

FIG. 5. Coercivity as a function of temperature. Note that there is hardly any change in coercivity until the temperature reaches 600 C. The temperature independent coercivity favors high temperature operation of these nanomagnets.

FIG. 6. Depicts the temperature dependence of saturation magnetization Mₛ and remanence magnetization Mᵣ.

FIG. 7. The self-alignment properties of doped DMNPs as observed by MFM (left) and by TEM (right). The individual DMNPs align due to magnetic interaction and lead to self-alignment with precision creating nanowires up to 10 μm size.

FIG. 8 on left-side, shows a 20 nm magnet where two rods of aligned magnets have joined together. The figure on right, shows MFM image of a nanomagnet that identifies attractive and repulsive ends of a true nanomagnet.

### DESCRIPTION OF THE PREFERRED EMBODIMENTS

### Magnetic Nanoparticles (MNP)

The origin of magnetism is the result of interaction of orbital and spin motions of electrons, hereafter just referred to as spins. How these interacting spins respond to externally applied magnetic field identify different types of magnetic materials such as diamagnetic, paramagnetic, ferromagnetic and antiferromagnetic materials. In the case of paramagnetic materials, the net magnetic moment is zero in the absence of applied magnetic field. Under an applied magnetic field, partial alignment of the atomic magnetic moments in the direction of the field results in a net positive magnetization. In paramagnetic materials, individual magnetic moments do not interact magnetically at room temperature or above. However, at low temperatures they can interact and under a magnetic field they leave remnant magnetization even after the field is removed. This is referred to as ferromagnetism. The temperature at which this occurs is called Curie temperature (T_{c}). All paramagnetic materials below T_{c} are ferromagnetic. However, nanomagnets lose the ferromagnetism as their size shrinks (cf. FIG. 1 herein).

In addition to usual paramagnetic or ferromagnetic materials, there are magnetic materials that are antiferromagnetic or ferrimagnetic materials. If the alternate sub-lattice moments are exactly equal but opposite, the net magnetic moment will be zero. This type of magnetic ordering is called anti-ferromagnetism. In ferrimagnets, the magnetic moments of the alternate sub-lattices are nearly equal and results in a small net magnetic moment. Ferrimagnetism is therefore similar to ferromagnetism. It exhibits all the hallmarks of ferromagnetic behavior: spontaneous magnetization; Curie temperatures; hysteresis; and remnant field. In case of ferromagnetic, antiferromagnetic and ferrimagnetic materials there is very different magnetic ordering at low temperatures. Nevertheless, most of these materials become paramagnetic at T_{c} and above.

In this patent application, we demonstrate that by introducing a dopant in a material that is paramagnetic at room temperature, we can raise the T_{c} to significantly higher than room temperature. Since most of the antiferromagnetic or ferrimagnetic materials are paramagnetic at about room temperature, we also convert the antiferromagnetic or ferrimagnetic materials to ferromagnetic materials. Being able to generate ferromagnetism in materials that are not naturally ferromagnetic and retain the ferromagnetic state at high temperatures opens new paths to many useful devices that will use abundant and hazardless elements, such as manganese and iron and eliminate the use of expensive rare-earth or toxic elements.

The magnetic materials such as cobalt, iron, nickel or magnetite (Fe₃O₄) exhibit very strong interactions among atomic moments. These interactions are produced by electronic exchange forces and result in a parallel or anti-parallel alignment of atomic moments. Such exchange forces are very large, equivalent to a magnetic field of the order of 1000 Tesla, or approximately a 100 million times the strength of the earth's field. The exchange force is a quantum mechanical phenomenon due to the relative orientation of the spins of two electrons. Ferromagnetic materials exhibit parallel alignment of moments resulting in large net magnetization even in the absence of a magnetic field. Even though electronic exchange forces in ferromagnets are very large, thermal energy eventually overcomes the exchange interaction as the temperature is increased and produces a randomizing effect on the spins at and beyond T_{c}. Below the Curie temperature, the ferromagnet spins are ordered. Above T_{C}, the spins are disordered and the ferromagnet converts to a paramagnetic or antiferromagnetic state.

In addition to the Curie temperature, ferromagnets can retain the memory of an applied field once it is removed. This behavior is called hysteresis and a plot of the variation of magnetization with an applied magnetic field is called a hysteresis loop. The measurement of hysteresis loops is expressed as coercivity in Oersteads (Oe).

### Size-Dependent Magnetism in Nanoparticles

If the MNP (Magnetic Nanoparticle) size is maintained below a critical size during nanoparticle synthesis, the MNPs tend to develop as single magnetic domain structures, and at the smallest sizes, they exhibit superparamagnetic behavior as discussed below. These size regimes are illustrated in FIG. 1. The first critical size corresponds to a transition from the multi-domain to the single-domain regime without a domain wall. A domain wall is a transition region between the different magnetic domains of uniform magnetization. The wall forms to minimize the magneto-static energy. The transition occurs when the size is energetically favorable for the magnetic nanoparticle to exist without a domain wall. This transition depends on three parameters: the exchange energy to keep the spins parallel, magnetization, and anisotropy of the nanoparticles. As shown in FIG. 1, as the size of the nanoparticles decrease below d₀, (the second critical size) the ferromagnetic properties such as coercivity and magnetic moment disappear and the material becomes paramagnetic or superparamagnetic. Superparamagnetism is a form of magnetism, which appears in small ferromagnetic or ferrimagnetic nanoparticles. In sufficiently small nanoparticles, magnetization can randomly flip direction under the influence of temperature. In this state, an external magnetic field is able to magnetize the nanoparticles, similarly to a paramagnet. However, their magnetic susceptibility is much larger than that of paramagnets. Utilizing the trend in FIG. 1, we have studied the role of a dopant in the regime where the material is superparamagnetic or paramagnetic. To develop ferromagnetic properties in small magnetic nanoparticles in the range of 2-30 nm, we have incorporated a magnetic ion and studied its role t in different magnetic materials. In this size range of 2-30 nm, the dopant drastically impacts the exchange energy (by keeping the spins parallel), magnetization, coercivity, and anisotropy of the nanoparticles. All these magnetic parameters show enhancement but more important they exhibit only weak temperature dependence.

### Magnetic Anisotropy

The magnetic properties of a material have a certain ‘preference’ or ‘stubbornness’ towards a specific direction. This phenomenon is referred to as ‘magnetic anisotropy’, and is described as the “directional dependence” of a material's magnetism. Changing this ‘preference’ requires a certain amount of energy. The total energy corresponding to a material's magnetic anisotropy is a fundamental constraint to the downscaling of magnetic devices like MRAMs, and computer hard drives. Magnetic anisotropy or the magnetic preference critically depends on the temperature. As the temperature increases, the preference decreases. Thus at higher temperatures, overall magnetization begins to rapidly decrease.

This work demonstrates the creation of superior magnetic properties such as: ferromagnetism, large coercivity, low saturation magnetization and increased T_{c} beyond 700° C. by doping MNPs. These magnetic properties at high temperatures differ significantly from the bulk materials, particularly the magnetic properties of the surface related spins of DMNP. As the particle size is reduced to a few tens of nanometers, the particle's properties are dramatically affected by the dopant, and a unified core-shell structure defines the nature of the DMNP. In the un-doped MNP, the core has the same properties as the homologous bulk sample, whereas the shell contains most of the crystallographic defects which induce uncompensated surface spins. The shell spins therefore constitute a disordered and magnetically dead layer, weakening the ferromagnetism (FM) of small nanoparticles.

In ferromagnetic MNPs, the effect of the shell-surface spins increases with decreasing size of the nanoparticle as a whole. Almost all MNPs are inhomogeneous because the spins of the surface and the interior of the particle are inherently dissimilar. We believe that one of the advances we have achieved by doping is that the spins of the core and shell become automatically aligned thereby creating a unified and integrated core-shell structure of spins. The enhanced magnetic properties which are then observed are a consequence of the disappearance of the dissimilar spin configuration between core and shell. We hypothesize that this is the result of dopant induced alignment of surface spins with the core spins. Dopant induced alignment of the spins on the surface is associated with the large enhancement of magnetic properties of DMNP and is claimed in this patent.

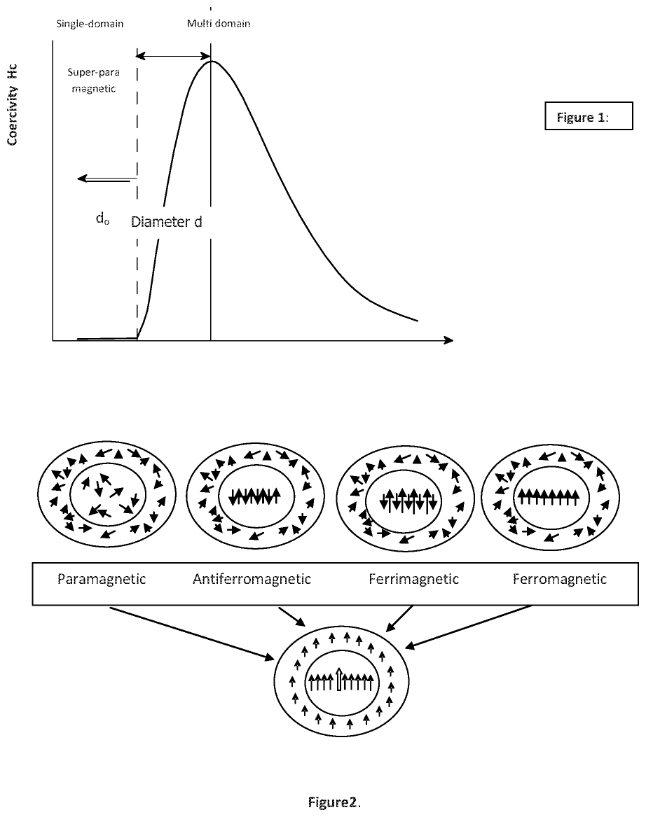

FIG. 2 depicts the role of a single dopant ion which converts paramagnetism, antiferromagnetism, ferrimagnetism and ferromagnetism to high temperature stable ferromagnetism. This is not only limited to magnetic properties but also to magneto-electric, magneto-optics, ferroelectric and other composite systems where localized spin control could play a role in controlling the magnetic property As shown in FIG. 1 above, the ferromagnetic behavior in MNP is reduced to superparamagnetic behavior when the size is below d₀. Such a trend also exists in antiferromagnetic and ferrimagnetic MNPs. A key reason for the change in the physical and chemical properties of small particles as their size decreases is the increasing proportionate number of the ‘surface’ atoms. From an energy stand point, a decrease in the particle size results in an increase in the proportionate fraction of the surface energy and thus its chemical potential.

This application utilizes the changes in the magnetic properties where the difference between bulk material and nanocrystals become especially pronounced. In particular, it is known that magnetization per atom and the magnetic anisotropy of nanoparticles can be much greater than those of a bulk specimen. The differences in temperatures corresponding to spontaneous parallel (Curie Point T_{C}) or antiparallel orientation of spins (Neel Temperature T_{N}), as applicable to nanoparticles as well as corresponding microscopic phases can differ by hundreds of degrees.

### Doping of Magnetic Nanoparticles

The magnetic properties of nanoparticles are determined by many factors. By changing the nanoparticle size, shape, composition and structure, one can control the magnetic characteristics of the material. In this application we demonstrate the effect of incorporating a single impurity atom in nanoparticles and how the magnetic properties are controlled during the synthesis.

Almost all nanoparticles are inhomogeneous because the properties of the surface (shell) and the interior (core) of the nanoparticles are inherently dissimilar as mentioned above. The effect of a dopant can be understood if we consider the size dependence of the “core-shell” model The differences in the spin alignment in the core and shell part of MNP are the key contributing factors in determining the magnetic properties at temperatures close to room temperature and above. The shell volume compared to core volume increases as the size of nanoparticles decrease. For all forms of magnetic behavior, the dopant plays an important role as depicted in FIG. 2.

Before reporting the changes in magnetic properties that are obtained by introducing a single magnetic dopant in MNP, we describe in a pictorial form what we anticipate is attained by dopant induced spin alignment of core and surface spins. This is shown in FIG. 2 at the lower half. In this section we illustrate how introduction of a single dopan [symbol] spin (shown as thick arrow) to paramagnetic, antiferromagnetic and ferrimagnetic MNPs results in ferromagnetic MNPs with aligned surface spins. It is known that in the case of ferromagnetic nanoparticles for sizes below 30 nm, disordering of surface-spins results in the loss of ferromagnetism and yields superparamagnetic MNP. When a dopant is incorporated in a ferromagnetic MNP as shown in FIG. 2 above, their ferromagnetic state continues to be unchanged but also improves to reach a state of high temperature ferromagnetism due to alignment of surface-spins. The core-shell heterostructure MNP disappears since all the spins across the interface of core and shell are now aligned and there is no dead layer from random surface-spin structure. Thus the two magnetic phases of core and surface spins that existed in un-doped MNP disappears yielding a single spin-aligned phase, thus yielding hysteresis and permanent magnetization. This leads to significantly different magnetic properties such as ferromagnetism and coercivity at very high temperatures as empirically observed and demonstrated in this patent. Additionally, it has been observed that appropriately engineered DMNPs when used as a contrast agent in MRI, will yield high resolution and high contrast images.

In this work, novel synthesis processing has been used to incorporate the dopants during the process of synthesis. Both choice of nanocrystalline host and the dopants are chosen carefully so that changes in the magnetic properties are controllably improved for different applications. All measurements conducted to distinguish the novel properties are described below along with the results. These observed results enabled by the underlying discovery will enables the development of nanomagnets that could provide basic building blocks for several technologies ranging from targeted delivery of medicine, integrated magnetic systems, very high density magneto-optical memories, sensors, self-assembled micro-devices and many more.

### Synthesis

For the incorporation of a dopant in MNPs, certain synthesis steps must be followed that result in the incorporation of a magnetic dopant atom and converts the paramagnetic MNPs to ferromagnetic nanoparticle. These conditions are very different than the conventional doping processes used in case of bulk semiconductors, phosphors and other crystalline materials. As an example, semiconductor p-n junction is formed by providing p or n type dopants and then redistributed by a diffusion process. The diffusion process is carried out at higher annealing temperatures, usually above 500° C. In the case of phosphors, the compounds that include host and the dopant are mixed and treated at higher temperatures near 1000° C. At these high temperatures, the redistribution of the dopant occurs due to the diffusion process, leading to a uniform doped phosphor.

It is important to note that the doping of MNP has to be carried out under very different conditions from those described above. First of all, we are limited to processing at lower temperatures since at high temperatures, the nanoparticles will sinter together to result in micrometer or larger size particles. To avoid high temperature synthesis for dopant incorporation, we have developed certain criteria that allows us to incorporate dopant in MNP at lower temperature as well as retain the nanoparticles size below 30 nm. Firstly, we chose the host that can be synthesized at reasonably low temperatures preferably below 100° C. These lower temperatures help to keep the particles size in the size range of 2-30 nm. However, at these low temperatures, the probability of dopant incorporation in the nanosize host decreases drastically. To overcome these barriers in the case of MNPs, we have carried out the synthesis of DMNP diligently following several rules;
i) The magnetic dopant ion has to be incorporated ‘in-situ’ while the host MNP is being grown.
ii) To make this incorporation viable and without introducing any strain in the host, we must have the charge state of the dopant the same as the host atom it is replacing. For example, in our case Fe²⁺ replaces Mn²⁺ in Mn₃O₄.
iii) The ionic-radius of the dopant should be close to the size of the host-ion it replaces. For case, size of Fe²⁺ is 0.80 Å, very close to Mn²⁺ 0.76 Å.
iv) Since we are dealing with MNPs, the magnetic moment of Fe²⁺ and Mn²⁺ should consist of a similar electron configuration i.e. both belong to transition metals category and their magnetic moment is derived from electrons in a similar electron bond.
v) In order to fix the alignment of the dopant spin and host spins in the same direction during growth, it is necessary to have an external magnetic field In our case we provide this magnetic field from a magnetic stirrer in the growth vessel.
   All the above experimental conditions when followed, have helped to synthesize DMNPs by different ways. To illustrate the synthesis of DMNPs, we have synthesized two DMNP systems; i) Mn₃O₄ doped with Fe and ii) Fe₃O₄ doped with Mn. Mn₃O₄ and Fe₃O₄ are ferromagnetic in nanosize less than 30 nm at low temperatures below T_{c} and are paramagnetic at room temperature. In both cases, when doped they have resulted in ferromagnetic nanoparticles at high temperatures beyond 500 C.

As an example of the synthesis for the case of DMNP of Mn₃O₄, we used a process where we dissolve MnCl₂ in deionized water. To this we add FeCl₂ with varying concentration from 0.2% up to 10% of the amount of total Mn concentration. After mixing slowly in the presence of a magnetic stirrer, the temperature of the solution is raised to 80° C. Drops of NH₄OH were added slowly to the heated solution of MnCl₂ and FeCl₂. The temperature can be varied from 50° C. to 90° C. for varying the size of the nanoparticles. Lower the temperature, smaller is the size. Furthermore, use of surfactant such as CTAB (Cetyl trimethylammonium bromide) along with MnCl₂, enables us to keep the particle size within a narrow distribution profile. With a reduction in synthesis temperature, a narrower distribution is obtained. The acid-base reaction creates nanoparticle precipitate of Mn₃O₄ doped with Fe²⁺. The precipitate of magnetic dark brown particles is washed in water several times utilizing magnetic field for separating the supernatant and the magnetic particles. The washed samples were dried at 80 C for about 18 hours. The dried powder shows ferromagnetism at room temperature and beyond, as measured by VSM technique described later. The dried powder was identified as Mn₃O₄ by X-ray diffraction.

We have also performed a reverse process where Fe₃O₄ is doped with Mn²⁺, to demonstrate that our dopant induced magnetism is also valid when the role of the dopant and host ions are reversed. For Mn²⁺ doping of the DMNPs of Fe₃O₄, we used a synthesis process where we dissolve Fe chlorides with iconicity Fe²⁺ and Fe³⁺ in 1:2 molar ratio in deionized water. The solution was stirred and heated to 80 C for an hour. NH₄OH was added to keep the pH value between 8 and 11. Black precipitate was identified as Fe₃O₄ by XRD. For both systems of Mn₃O₄:Fe²⁺ and Fe₃O₄:Mn²⁺, we have characterized the ferromagnetic properties using VSM, MFM and TEM. For identify the unique properties of these newly found ferromagnetic DMNPs, we characterize and discuss in detail a sample that contain 0.5% Fe²⁺ in Mn₃O₄.

### Structural and Magnetic Data

### Transmission Electron Microscopy (TEM)

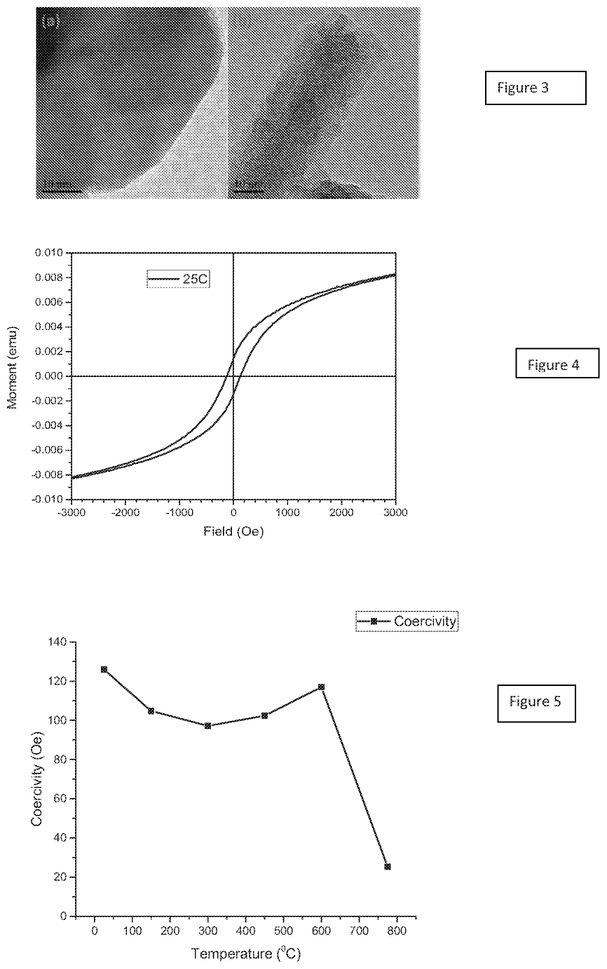

The crystalline structure of synthesized DMNP of Mn₃O₄ doped by Fe²⁺ was confirmed to be a spinel structure by X-Ray diffraction (XRD). Due to doping of Mn₃O₄ by Fe²⁺ ion in this tetragonal structure is anticipated that the crystalline axis and magnetic axis become collinear. This is demonstrated in TEM data discussed below. When the angle between the two axes, referred to as canting angle is zero, the ferromagnetic properties improve significantly. This alignment of two axes, crystalline and magnetic axes is novel, and occurs during the formation of DMNP's in the size range of size between 2-30 nm and associated with the exchange interaction between the dopant spin and the host spins in DMNP. This is consisted with high resolution image obtained by High Resolution Transmission Electron Microscopy (HR-TEM) and shown in shown in FIG. 3. Nanoparticles without a dopant, agglomerate and do not show any magnetic interaction among themselves as shown on the left side micrograph. On the right the DMNPs are interacting to form nanowire like structure where the embedded nanoparticles are aligned along the crystalline lattice. This is the effect of the incorporation of the Fe dopant in Mn₃O₄.

A HR-TEM image of DMNP as shown on the right hand side of FIG. 3, depict that the nanoparticles of size 10-20 nm are present with the observed crystalline lattice direction being parallel to the direction of the alignment of the magnetic nanoparticles. Thus in DMNP, we observe that the crystalline axis and magnetic axis are collinear. We believe that the merger of the crystalline axis and magnetic axis in a self-assembled nanowire is partially responsible for the high temperature ferromagnetism in DMNP.

### Ferromagnetism in Doped MNPs

We have conducted experiments with different concentrations of Fe-ion in Mn-oxide to study their magnetic properties. Most studied is Mn₃O₄ because of its spinel crystal structure and its ferromagnetic behavior at temperatures where it is normally paramagnetic. We wanted to observe the effect of incorporation of a single dopant Fe-ion in Mn₃O₄ nanoparticles. Mn₃O₄ is known as Hausmanite mineral which falls under the category of tetragonal spinel symmetry. Mn₃O₄ consists of edge sharing MnO₆ octahedra which are corner connected to MnO₄ tetrahedra. Therefore, valence states of Mn in Mn₃O₄ are +2 and +3. We have used Fe²⁺ ions to replace Mn²⁺ because the ionic radii are 0.80 Å and 0.76 Å, respectively. It is easier to incorporate Fe²⁺ in place of Mn²⁺. Both ions possess good magnetic moment, Mn²⁺=5.9 μ_{B} and Fe²⁺=4.9 μ_{B}, respectively where μ_{B} is the Bohr Magneton, a unit of atomic magnetic moment. Normally Mn₃O₄ is paramagnetic above Curie point of 41 K and it forms non-collinear magnetic structure that consists of ferromagnetically coupled Mn²⁺ cations along the (010) direction and two Mn³⁺ sub lattices with a net moment that couples antiferromagnetically to the magnetization of Mn²⁺ cations (M Kim et al Phys. Rev. B 84, 174424,2011)

The magnetic moment as a function of magnetic field was measured at temperatures ranging from 25 C to 800 C using a vibrating sample magnetometer (VSM) system. These series of measurements allowed us to measure Magnetic moment (in units of emu/gm), saturation magnetization Ms, Coercivity, H_{c}, (in units of Oe) as a function of temperature. We varied the concentration of dopant ion Fe²⁺ from 0.2% to 10% of total Mn concentration in the starting material. All the ferromagnetic effects observed are very similar, so much so that we conclude that there was no direct role of Fe concentration but only indirect as a dopant in Mn₃O₄. Fe²⁺ is likely to replace Mn²⁺ in Mn₃O₄ spinel structure. As an example, in 5 nm size of Mn₃O₄, when Fe²⁺ replaces substitutional Mn²⁺, the single Fe²⁺ ion is polarized due to quantum confinement in nanocrystal of Mn₃O₄. This polarized Fe²⁺ ion produces a very high magnetic field (>10000 Gauss) at the nearest neighbor site and polarizes the spin. This cascade polarization process continues for all the spins of Mn²⁺ and Mn³⁺ with the end result that all Mn-ions are polarized in the same direction. The induced polarization of spins both among the core spins and surface spins, concurrently is responsible for the ferromagnetism in DMNPs. This is depicted in FIG. 2, where in all cases of paramagnetic, ferrimagnetic, antiferromagnetic and ferromagnetic nanoparticles, core and surface alignment leads to strong ferromagnetic behavior. Furthermore, we believe that the anomalous ferromagnetism observed in DMNPs and its unique high temperature dependence is likely to be due to this collinear alignment of all cores and surface spins along the crystalline axis. The exchange interaction in DMNP is strong enough to retain ferromagnetism beyond 770 C, as shown in FIG. 5

Several measured magnetic properties associated with ferromagnetism in DMNP where concentration of Fe²⁺ with respect total Mn-ion concentration was varied from 0.5% to 10% have been listed in table I. The variability in these results are primarily due to the variation in the size of these nanoparticles. The magnetic properties are very sensitive to dopant incorporation and the size of the host nanoparticles. We simply characterizing DMNP with 0.5% Fe²⁺ concentration as an example.

TABLE I
Magnetic Parameters at Room Temperature (25 C.)

| Concentration of | Saturation | | Remanence |
|---|---|---|---|
| Dopant | magnetization Mₛ | Coercivity | Magnetization |
| (weight %) | (emu/gm) | H_{c} (Oe) | Mᵣ (emu/gm) |
| 0 | 0.82 | 0 | 0 |
| 0.2 | 2.40 | 166.8 | 0.41 |
| 0.5 | 1.88 | 125.9 | 0.36 |
| 2.0 | 1.87 | 52.1 | 0.14 |
| 5.0 | 3.03 | 43.1 | 0.24 |
| 10.0 | 4.01 | 209.4 | 0.8 |

The hysteresis measurement (magnetization M vs. applied magnetic field-H) is the principal measurement to characterize the key properties of ferromagnetic materials. So the measurement was performed in the temperature range from 25 C to 775 C, for a sample containing 0.5% of dopant Fe²⁺. A hysteresis curve for the Mn₃O₄ for 0.5% Fe sample is shown in FIG. 4.

Hysteresis width, measured in units of Oersted (Oe), signifies how strong the retention of magnetism is in the nanomagnet. It is known that as the size of the MNP decreases, its ability to keep the spins aligned decreases because the net magnetic anisotropic energy becomes less than the thermal energy. This was shown in Table 1. By 0.5% Fe dopant introduction we have induced the alignment of all the host spins, thereby eliminating the temperature dependence of hysteresis. In fact, the alignment is so strong that the coercivity remains significant until 775 C, as shown in FIG. 5.

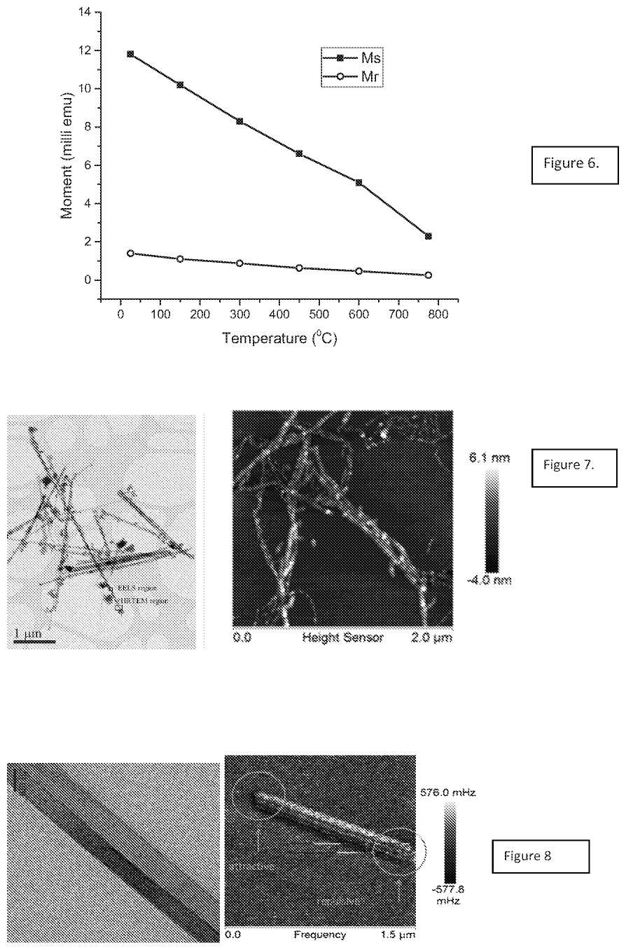

We have extended the temperature dependent coercivity measurement to dependence of saturation magnetization Mₛ and remanence magnetization Mᵣ on temperature. FIG. 6 shows this dependence. Both Mₛ and Mᵣ show a linear decrease as a function of temperature.

The temperature dependence data for the 0.5% Fe doped Mn₃O₄ is summarized in table II below.

TABLE II

| Temp (° C.) | Mₛ (milliemu) | Mᵣ (milliemu) | H_{c} (Oe) |
|---|---|---|---|
| 25 | 11.8 | 1.4 | 125.9 |
| 150 | 10.2 | 1.1 | 104.8 |
| 300 | 8.3 | 0.88 | 97.2 |
| 450 | 6.6 | 0.63 | 102.4 |
| 600 | 5.1 | 0.47 | 117 |
| 775 | 2.3 | 0.26 | 25.3 |

From above magnetic measurements we summarize that;
1. We have converted the paramagnetic Mn₃O₄ to ferromagnetic MNP by doping with Fe²⁺ in the concentration range of 0.2% to 10% of Mn-ion concentration.
2. All of the DMNPs remain ferromagnetic until ˜800 C. The change of the ferromagnetic behavior from 25 C to 600 C is rather weak as shown in table II
3. The result in #2 above is novel when compared to the temperature dependence of un-doped 10 nm size Fe₃O₄, a ferromagnetic nanoparticle, where the magnetic moment drops 30% for a temperature change between −73° C. to 25° C.
4. The weak temperature dependence of ferromagnetism in DMNPs is due to incorporation of Fe as dopant and believed to be due alignment of the Mn²⁺ and Mn^{3*} spins in spinel structure of Mn₃O₄.
   To further test the hypothesis that the alignment of the spins in Mn₃O₄ is due to the incorporation of Fe-ion, we performed atomic force microscopy (AFM), magnetic force microscopy (MFM) and high resolution transmission electron microscopy (HR-TEM).

### Atomic Force Microscopy (AFM), Magnetic Force Microscopy (MFM) and Transmission Electron Microscopy (TEM) Measurements

Undoped Mn₃O₄ does not show any ferromagnetic behavior. However, at low Fe-doping concentration of 0.2% and 0.5%, we observe high temperature ferromagnetism, HT-FM. Using AFM and MFM measurements; we have attempted to understand the self-assembly process and relate this to anomalous HT-FM and reach certain conclusions. One of the observations to be noted is that magnetic axis (or easy axis) becomes collinearly aligned with one of the crystallographic axis (Z-axis) thereby generating HT-FM.

Magnetic Force Microscopy (MFM) data show that the Fe doped Mn₃O₄ nanoparticles are lined up due to strong magnetic attraction between the particles. This is also evident from the frequency response of the magnetic tip. However, un-doped Mn₃O₄ particles do not show such phenomenon (see FIG. 7). It is important to note that the Fe doped nanoparticles individually are close to 20 nm or less, but because of its magnetic interaction, they can align perfectly over 10 micrometers (see FIG. 8). (MFM data show that the Fe doped Mn₃O₄ nanoparticles are lined up due to strong magnetic attraction between the particles. This is also observed in the frequency response of the magnetic tip. However, un-doped Mn₃O₄ particles do not show this phenomenon.

In FIGS. 8 and 9, we have made a comparative study between the MFM data and what is observed with TEM among the un-doped and doped MNPs. MFM picture compares favorably with the HRTEM picture of Fe-doped MNP in FIG. 9. TEM images also support the AFM/MFM observation of lining up of particles. Both MFM and high-resolution TEM (HRTEM) suggest strongly that ferromagnetic DMNP are interacting as individual nanomagnets. This reveals the importance of the doping of MNP not only for ferromagnetic behavior but also to create macro-nanomagnets with high temperature capability. Magnetic moment of 0.5% Fe doped Mn₃O₄ measured from VSM matches with the magnetic moment calculated from the MFM data. One of the surprising observations is saturation magnetization (Mₛ) and remnant magnetization (Mᵣ) show significantly high values even at 750° C. We also observed that coercivity shows a weak dependence on temperature with a reasonable high value (40 Oe) at 750° C.

### Applications of Doped Magnetic Nanoparticles (DMNP)

In this work we considered the applications of DMNPs in targeted drug delivery, high contrast agent for MRIs, high strength magnets, magnet levitation, nanomagnetic memory arrays and nanomagnet photonic devices such as display arrays. Above we considered the properties of Fe doped Mn₃O₄. The temperature dependence of the ferromagnetic parameters is startlingly unique especially when it is realized that the original host MNPs are poorly paramagnetic at room temperature.

The self-organized magnetic nanowires (see FIG. 8), when separated from the other non-ferromagnetic MNPs, could yield much larger magnetic moment and coercivity. This is estimated for our sample with Fe doping. The observed net magnetic moment at 5000 Oe is 1.88 emu/gm for 0.5% Fe sample. For un-doped MNP it is 0.82 emu/gm. If we assume that only x fraction of the Fe-doped particles are in the size range below 30 nm and (1−x) of the particles are not contributing to ferromagnetism then we have xy+(1−x)0.82=1.88 emu/gm, where y is the magnetic moment value of DMNPs with Fe as dopant. Solution of above equation yields y=0.82+(1.06/x) emu/gm. This solution shows that for any reasonable estimate of the fraction that in the size range below 30 nm the value of y is very much larger than the measured value of 1.88 emu/gm. This suggests that the DMNPs not only show ferromagnetism but also possess much higher magnetic moment. To exploit the higher magnetic moment, we need to separate DMNPs from MNPs, preferably by magnetic field separation. Since, we are able to engineer the properties of 2-30 nm size several applications become available to us. We discuss each of the applications in detail.

### Targeted Drug Delivery

By utilizing nanomagnets as a vehicle for targeted drug delivery we can make a large difference in the therapeutic treatments that involve localization of injectable drugs. The paramagnetic and super-paramagnetic MNP's require an application of a magnetic field gradient to exert force and concentrate the drug molecules at a given site inside the body. However, it is very difficult to create a gradient beyond a depth of a few centimeters. If we use ferromagnetic MNP i.e. nanomagnets they are likely to clump at locations different than the targeted site. Also in all cases, the size of the MNPs with coating ought to be less than 60 nm. This in turn limits the size of uncoated particle to be 30 nm. Most of the MNPs that are non-toxic, such as Fe-oxide, lose their ferromagnetic behavior below 40 nm. Thus, to succeed for targeted drug delivery, we can engineer nanoparticles that are ferromagnetic at sizes below 30 nm.

To overcome these issues we have developed DMNPs that remain paramagnetic until exposed to a uniform magnetic field and then turn into ferromagnetic for collection at the needed site. Described below are the properties of DMNPs that are needed, and the specific conditions that facilitate an optimized targeted drug delivery system:
1. The magnetic moment of the MNP should be such that they do not agglomerate because of dipole-dipole interaction i.e. they should be paramagnetic with no magnetic moment in the absence of magnetic field. This must be maintained during blood circulation and extravasation process after i.v. administration.
2. If MNPs are paramagnetic, they can only be collected at a given site under the gradient of the applied magnetic field. Such a gradient exists only a short distance (maximum a few centimeters) from the magnetic pole. Hence the MNPs can only be concentrated close to the surface of the skin. This restricts the collection of MNPs at the site of a majority of cancerous tumors and other ailments in humans.
3. To overcome this shortcoming of targeted drug delivery, we have improvised and engineered DMNPs such that they can be concentrated with an applied homogeneous magnetic field at the specific organ throughout the body.
4. For the delivery process to work, we need to start the DMNPs as paramagnetic with appropriately coated surfactant and drug so as not to agglomerate as injected in the blood stream.
5. At the cancerous tumor due to enhanced permeation and retention (EPR) effect the collection process begins to deliver the drug coated DMNPs.
6. The DMNPs are designed such that they are paramagnetic without the externally applied magnetic field but become ferromagnetic with rather small homogeneous applied magnetic field.
7. When homogenous magnetic field is focused at the tumor site, DMNPs with drug that have been collected due EPR effect promptly become ferromagnetic generating a strong dipole-dipole interaction among each other. The attractive magnetic force stimulates the collection process and begins condensation of drug coated particles at the tumor site.
8. The attractive dipole-dipole force among ferromagnetic nanoparticles stimulates and amplifies the collection process and begins condensation of drug coated particles at the tumor site.
9. Normally, via EPR effect typically less than 1% of the injectable drug dosage is collect at the tumor site. However, with under the application of magnetic field and drug coated DMNP we expect to increase the dosage collection of the injectable dosage up to perhaps 10%. One should note that without the application of magnetic field, DMNPs will remain paramagnetic and will not have inter-particle attraction and collect sufficiently at the tumor site. Under the application of magnetic field DMNPs become ferromagnetic generating a strong inter-particle interaction. Such a magnetic interaction is likely to be absent among current ferromagnetic MNPs since their surface spins are disordered and remain paramagnetic.
10. The fact that we retain strong ferromagnetic behavior at high temperature (>700 C), it suggests inter-particle interaction among the DMNPs will not only induce collection but will remain in the tumor for significant time. The dipole-dipole interaction among the nanomagnets will maintain the concentration for longer duration, leading to much shorter therapeutic treatment time.
11. The invention of creating paramagnetic DMNPs that convert to ferromagnetic DMNPs under applied magnetic field helps us to establish a unique process of delivering and retaining the DMNPs at the tumor site.
12. Since these DMNPs are magnetic, high contrast MRI images will enable observation in real time of the therapeutic effects of the delivered drug.
13. A true targeted drug delivery system would then be available.

### Contrast Agent for High Contrast MRI

By doping of MNP's, we have aligned the core and surface spins to improve the magnetic moment of DMNPs. The MRI contrast depends directly on the magnetic moment of the MNPs when used as a contrast agent. Thus, controlling the magnetic moment through alignment of spins could be major contributor for improvement of MRI contrast. Theoretically, it is predicted that if we could align the spins on the surface of a nanoparticle, the relaxation rate of the proton can be enhanced by several orders of magnitude (S. Koenig and K. E. Kellar: Magn. Reson Med. 34, 227-33,1995). We anticipate that by controlling the surface-spins and aligning them with a dopant, the contrast associated with relaxation rate 1/T₁ which is responsible for positive images, could be improved by 10× to 100×. In order to do so, one needs to control the size, shape and most of all control the alignment of spins on the surface. Thus, Mn-based DMNPs are expected to impact the next generation of MRI diagnosis for not only improved contrast but also reduction of toxicity of contrast agent.

### Hyperthermia

A type of treatment in which body tissue is exposed to high temperatures to damage and kill cancer cells or to make cancer cells more sensitive to the effects of radiation and certain anticancer drugs. The idea that a localized rise in temperature (typically about 432 C) can be used to destroy malignant cells selectively is referred as hyperthermia. This method of treatment is very suited for DMNP's by activating these ferromagnetic nanoparticles by an applied alternating magnetic field (AMF). Magnetic nanoparticle based hyperthermia is also being studied as an adjuvant to conventional chemotherapy and radiation therapy. We believe that our ferromagnetic engineered DMNP's can overcome the earlier limitations to make magnetic hyperthermia treatment (MHT) a practical realty. DMNP possess Significant advantages over conventional MNP is that we have controlled ferromagnetism with dopant and in the size range of 30-70 nm

### High Efficacy Nanomagnets for High Temperature Operation

We have shown that Fe doped Mn₃O₄, referred as Fe-DMNP, shows ferromagnetic properties that persists at temperatures beyond 973° K. (˜800 C). This behavior is very anomalous since un-doped Mn₃O₄ has a Neel Temperature of 41° K. (−236 C). From all the data we have observed on individual nanoparticles, we conclude that the while Mn₃O₄ nanocrystals are growing in the presence of Fe²⁺ ion, its incorporation aligns the magnetic axis with the axis of crystal growth for small nanoparticles. The collinearity modifies the magnetic properties particularly the temperature dependence. The TEM images in FIG. 8a, below show an aligned nanomagnet, suggesting that the growth axis and magnetic axis are collinear. In FIG. 8b, we show an MFM image of nanomagnet where magnetic attractive and repulsive end are identified as the north and south pole of a ‘nanomagnet’. FIG. 8 depicts strong indication of self-aligned and self-assembled nanomagnets to be integrated for different electromechanical applications.

The atomic spins align and lead to a ferromagnetic material. In our case we are using 20 nm size nanoparticles with well-defined spins that are acting like super atoms and are generating super-ferromagnets. Super-ferromagnets are capable of retaining ferromagnetism at very high temperatures.

Macro-size magnets can be formed by embedding DMNP micro-rods (see FIG. 8b) in molten metal. Since the micro-rods retain their magnetism to temperatures above the melting temperatures of many metals, for example aluminum, a uniform magnetic field will align all the micro-rods. This procedure will provide high coercivity magnets that can be molded into many shapes. These magnets can be used for magnetic bearings that levitate the bearing's load. Magnetic levitation provides frictionless bearings and surfaces since there is an air gap between the bearing surfaces. For example the bearings of wind turbines can be made with reduced friction and hence improved efficiency. Or the magnets can be formed into magnet armatures for micro to macro sized motors high efficiency motors and electrical generators.

The integration of super-ferromagnets will provide integrated magnetic circuits and generate new kinds of memory devices or remote access controls. Since the magnetic field from each nanomagnet couples with the next, and a north-south oriented magnet induces south-north pole in the adjacent one and so on (refer FIG. 8b), one can pass the information down the chain of nanomagnets. Additionally, these nanomagnets can be embedded with electronic circuits to be addressed magnetically. We have additional advantage that these DMNP based magnets work at high temperatures. The localization of magnetic field can be achieved by utilizing mu-metal (an alloy of Ni, Cu, Fe and Mo) aperture to shield the field and guide the magnetic field to given site.

### Nanomagnetic Arrays

Nanomagnetic arrays will be fabricated using an array of equally spaced nano-conductors, arranged beneath a perpendicular set of similar nano-conductors with a thin dielectric layer between them. The array of nano-magnets is formed using the unique property of these DMNPs, i.e. in the absence of a magnetic field, DMNPs behave as separate nanoparticles that become strongly magnetic in a uniform magnetic field. A slurry of suitably sized DMNPs is spread over the array of conductors. Pulsed and/or continuous current is passed through the conductors to produce a strong enough magnetic field to attach each DMNP at the intersection of the conductors. The DMNP's polarity can be fixed by passing the array under a strong magnetic field. There are numerous means of fixing the DMNPs to the top layer of/over the array of conductors including using ferrous metals and magnetism on the top conductor array to chemical “glue” that attaches the DMNP to the intersection spots on a suitable supporting film. These arrays can be used with light through the magneto-optic Kerr or Faraday effect particularly for optical transmission switches and Mux/De-mux units.

1. A nanoparticle comprising a transition metal host magnetic compound of size 2-30 nm having a transition metal dopant atom incorporated therein, the dopant atom having an intrinsic magnetic moment, size and valence state similar to the host compound such that the nanoparticle exhibits ferromagnetism when subject to a magnetic field.

2. The nanoparticle of claim 1 wherein the host nanoparticle is paramagnetic, antiferromagnetic, ferrimagnetic or weak ferromagnetic, which upon having a transition metal dopant atom incorporated therein, is transformed to ferromagnetic material.

3. The nanoparticle of claim 1 wherein the nanoparticle is ferromagnetic between 25° C. and 700° C.

4. The nanoparticle of claim 1 wherein the host is Mn₃O₄ and the dopant is Fe.

5. The nanoparticle of claim 1 wherein host is Fe₃O₄ and dopant is Mn.

6. The nanoparticle of claim 1 wherein the dopant is 0.5 weight % of the host.

7. The nanoparticle of claim 1 formed into an array of nanoparticles and used in combination with an electronic chip for magneto-electric chip array.

8. The nanoparticle of claim 1 formed into an array of nanoparticles and used as a magnetic sensor.

9. The nanoparticle of claim 1 formed into an array of nanoparticles, the nanoparticles integrated into a metallic matrix to generate macro-magnets with coercivity greater than 200 Oe at temperatures >500° C.

10. The nanoparticle of claim 1 formed into an array of nanoparticles, the nanoparticles being coated to be used in vivo applications.

11. The nanoparticle of claim 1 formed into an array of nanoparticles for targeted drug delivery under an applied magnetic field.

12. The nanoparticle of claim 1 formed into an array of nanoparticles for being heated under an applied AC magnetic field.

13. A method for producing ferromagnetic nanoparticles comprising:
a) supplying a precursor compound for a paramagnetic, antiferromagnetic, ferrimagnetic or weak ferromagnetic host ionic compound;
b) supplying a precursor compound for a magnetic dopant ion, the charge state of the dopant ion being the same as the host atom it is replacing, the ionic-radius of the dopant being close in ionic radius of the host it replaces with the magnetic moment of the host ion and dopant ion having a similar electron configuration;
c) reacting the precursors of the host and dopant wherein tine dopant ion is incorporated in-situ while the host MNP is being grown; and
d) applying an external magnetic field during growth to fix the alignment of the dopant spin and host spins in the same direction during growth.

14. The method of claim 13 wherein the proportions of the host and dopant precursors are adjusted so that the dopant is 0.5 weight % of the host.

15. The method of claim 13 wherein the host is Mn₃O₄ and the dopant is Fe.

16. The method of claim 13 wherein the host is Fe₃O₄ and dopant is Mn.
